(19) United States
(12) Patent Application Publication
(10) Pub. No.: US 2017/0181090 A1
(43) Pub. Date: Jun. 22, 2017

(54) STATION (STA), ACCESS POINT (AP), AND METHOD FOR COMMUNICATION OF WAKE-UP CONFIGURATION MESSAGES

(71) Applicant: Intel Corporation, Santa Clara, CA (US)

(72) Inventors: Minyoung Park, Portland, OR (US); Shahrnaz Azizi, Cupertino, CA (US); Alexander W. Min, Portland, OR (US); Thomas J. Kenney, Portland, OR (US)

(21) Appl. No.: 14/979,353

(22) Filed: Dec. 22, 2015

(51) Int. Cl. H04W 52/02; H04W 72/04

(52) U.S. Cl. CPC H04W 52/0235; H04W 72/042

(57) ABSTRACT

Embodiments of a station (STA), access point (AP) and method for communication in accordance with wake-up messages are generally described herein. The STA may transmit, to the AP, a wake-up configuration message that indicates a Resource Unit (RU) in which the STA intends to monitor for wake-up messages from the AP during a sleep period. The STA may receive a wake-up message from the AP during the sleep period. The wake-up message may be included in an orthogonal frequency division multiple-access (OFDMA) signal that may include other wake-up messages for other STAB. The wake-up message may be transmitted by the STA in accordance with enhanced distributed channel access (EDCA) techniques in some cases.

### TECHNICAL FIELD

Embodiments pertain to wireless networks. Some embodiments relate to wireless local area networks (WLANs) and Wi-Fi networks including networks operating in accordance with the IEEE 802.11 family of standards, such as the IEEE 802.11ac standard or the IEEE 802.11ax study group (SG) (named DensiFi). Some embodiments relate to high-efficiency (HE) wireless or high-efficiency WLAN or Wi-Fi (HEW) communications. Some embodiments relate to wake-up messages. Some embodiments relate to multiple-input multiple-output (MIMO) communications and orthogonal frequency division multiple access (OFDMA) communication techniques.

### BACKGROUND

Wireless communications has been evolving toward ever increasing data rates (e.g., from IEEE 802.11a/g to IEEE 802.11n to IEEE 802.11ac). In high-density deployment situations, overall system efficiency may become more important than higher data rates. For example, in high-density hotspot and cellular offloading scenarios, many devices competing for the wireless medium may have low to moderate data rate requirements (with respect to the very high data rates of IEEE 802.11ac). A recently-formed study group for Wi-Fi evolution referred to as the IEEE 802.11 High Efficiency WLAN (HEW) study group (SG) (i.e., IEEE 802.11ax) is addressing these high-density deployment scenarios.

### BRIEF DESCRIPTION OF THE DRAWINGS

FIG. 1 illustrates a wireless network in accordance with some embodiments;

FIG. 2 illustrates a block diagram of an example machine in accordance with some embodiments;

FIG. 3 illustrates a station (STA) and an access point (AP) in accordance with some embodiments;

FIG. 4 illustrates the operation of a method of communication in accordance with some embodiments;

FIG. 5 illustrates an example wake-up configuration message in accordance with some embodiments;

FIG. 6 illustrates example mappings between Resource Unit (RU) indexes and RU frequencies in accordance with some embodiments;

FIG. 7 illustrates example mappings between RU indexes and RU frequencies in accordance with some embodiments;

FIG. 8 illustrates example mappings between RU indexes and RU frequencies in accordance with some embodiments; and

FIG. 9 illustrates the operation of another method of communication in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

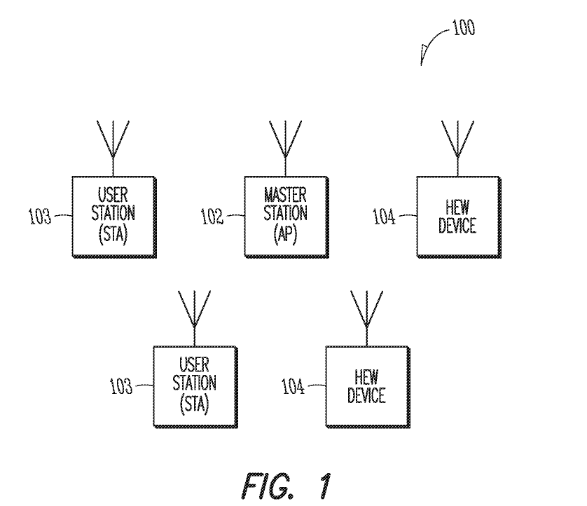

FIG. 1 illustrates a wireless network in accordance with some embodiments. In some embodiments, the network 100 may be a High Efficiency Wireless Local Area Network (HEW) network. In some embodiments, the network 100 may be a Wireless Local Area Network (WLAN) or a Wi-Fi network. These embodiments are not limiting, however, as some embodiments of the network 100 may include a combination of such networks. That is, the network 100 may support HEW devices in some cases, non HEW devices in some cases, and a combination of HEW devices and non HEW devices in some cases. Accordingly, it is understood that although techniques described herein may refer to either a non HEW device or to an HEW device, such techniques may be applicable to both non HEW devices and HEW devices in some cases.

The network 100 may include a master station (STA) 102, a plurality of user stations (0) 103 and a plurality of HEW stations 104 (HEW devices). In some embodiments, the STAs 103 may be legacy stations. These embodiments are not limiting, however, as the STAs 103 may be HEW devices or may support HEW operation in some embodiments. The master station 102 may be arranged to communicate with the STAs 103 and/or the HEW stations 104 in accordance with one or more of the IEEE 802.11 standards. In accordance with some HEW embodiments, an access point may operate as the master station 102 and may be arranged to contend for a wireless medium (e.g., during a contention period) to receive exclusive control of the medium for an HEW control period (i.e., a transmission opportunity (TXOP)). The master station 102 may, for example, transmit a master-sync or control transmission at the beginning of the HEW control period to indicate, among other things, which HEW stations 104 are scheduled for communication during the HEW control period. During the NM control period, the scheduled HEW stations 104 may communicate with the master station 102 in accordance with a non-contention based multiple access technique. This is unlike conventional Wi-Fi communications in which devices communicate in accordance with a contention-based communication technique, rather than a non-contention based multiple access technique. During the HEW control period, the master station 102 may communicate with HEW stations 104 using one or more HEW frames. During the HEW control period, STAB 103 not operating as HEW devices may refrain from communicating in some cases. In some embodiments, the master-sync transmission may be referred to as a control and schedule transmission.

In some embodiments, the STA 103 may transmit a wake-up configuration message to the AP 102. The AP 102 may transmit a wake-up message to the STA 103. The wake-up message may be transmitted as part of an orthogonal frequency division multiple access (OFDMA) signal. In some cases, the OFDMA signal may include multiple wake-up messages for multiple STAs 103. These embodiments will be described in more detail below.

In some embodiments, the multiple-access technique used during the HEW control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique including a multi-user (MU) multiple-input multiple-output (MIMO) (MU-MIMO) technique. These multiple-access techniques used during the HEW control period may be configured for uplink or downlink data communications.

The master station 102 may also communicate with STAs 103 and/or other legacy stations in accordance with legacy IEEE 802.11 communication techniques. As an example, an enhanced distributed channel access (EDCA) protocol may be used in the uplink and/or the downlink. As another example. OFDMA techniques may be used for downlink communication while EDCA techniques may be used for uplink communication. In some embodiments, the master station 102 may also be configurable to communicate with the HEW stations 104 outside the HEW control period in accordance with legacy IEEE 802.11 communication techniques, although this is not a requirement.

In some embodiments, the HEW communications during the control period may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, sub-channel bandwidths less than 20 MHz may also be used. In some embodiments, the communication may be performed in channel resources that may comprise a bandwidth of 20 MHz, 40 MHz, 80 MHz, 160 MHz or 320 MHz. The channel resources may comprise one or more 20 MHz channels. These example bandwidths for the channel resources and channels are not limiting, however, as other suitable values may be used. In these embodiments, each channel or sub-channel of an HEW communication may be configured for transmitting a number of spatial streams.

In accordance with embodiments, a master station 102 and/or HEW stations 104 may generate an HEW packet in accordance with a short preamble format or a long preamble format. The HEW packet may comprise a legacy signal field (L-SIG) followed by one or more high-efficiency (HE) signal fields (HE-SIG) and an HE long-training field (HE-LTF). For the short preamble format, the fields may be configured for shorter-delay spread channels. For the long preamble format, the fields may be configured for longer-delay spread channels. These embodiments are described in more detail below. It should be noted that the terms “HEW” and “HE” may be used interchangeably and both terms may refer to high-efficiency Wireless Local Area Network operation and/or high-efficiency Wi-Fi operation.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

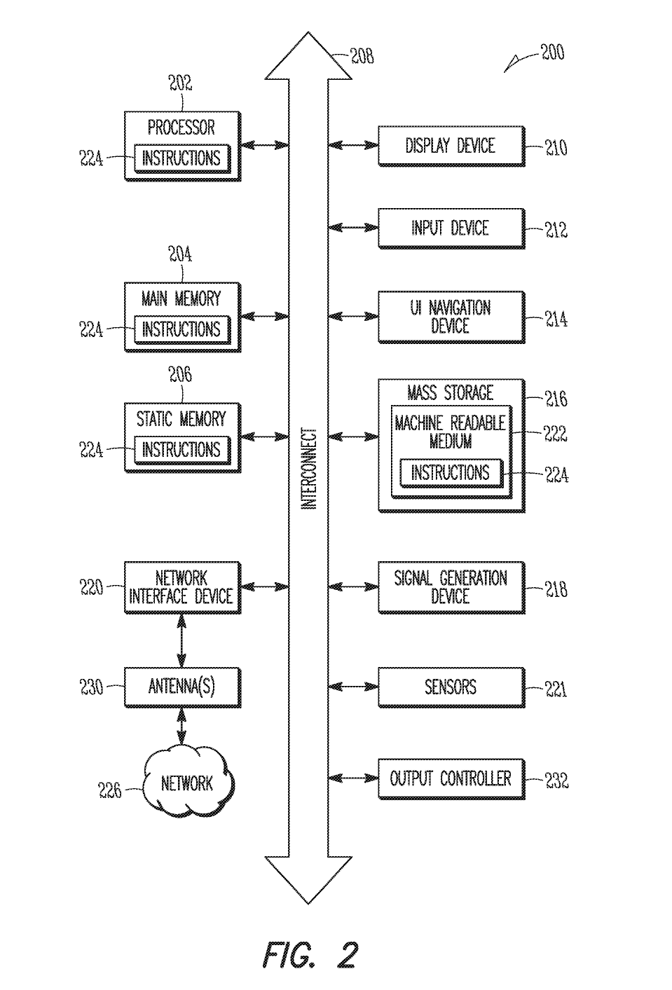

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be an AP 102, STA 103, HEW device 104, UE, eNB, mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UT) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine readable medium may be or may include a non-transitory computer-readable storage medium.

While the machine readable medium 222 is illustrated as a single medium, the term “machine readable medium” may include a single medium or multiple media (e.g., a centralized or distributed database, and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMITS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

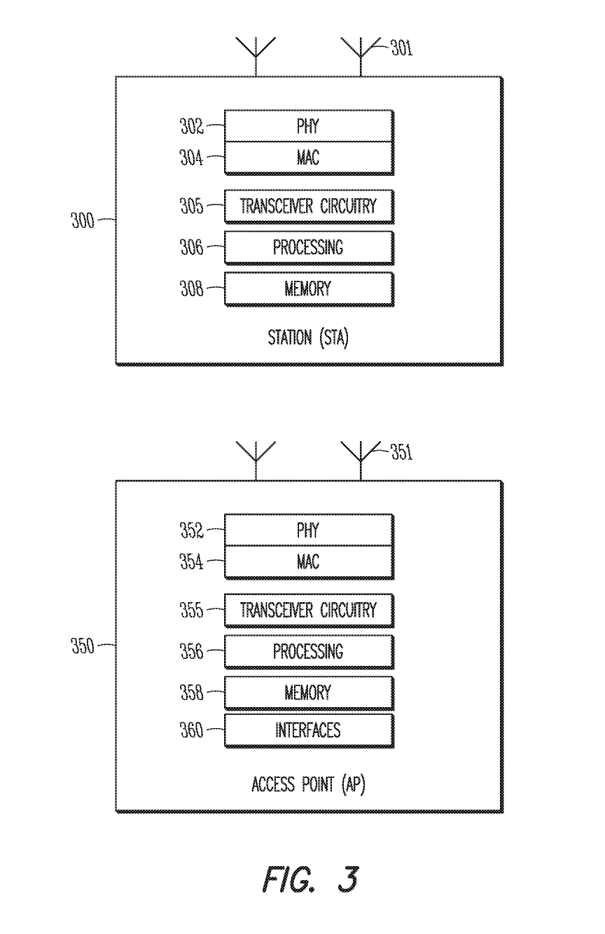

FIG. 3 illustrates a user station (STA) and an access point (AP) in accordance with some embodiments. It should be noted that in some embodiments, an STA or other mobile device may include some or all of the components shown in either FIG. 2 or FIG. 3 (as in 300) or both. In addition, an AP or other base station may include some or all of the components shown in either FIG. 2 or FIG. 3 (as in 350) or both, in some embodiments. It should also be noted that in some embodiments, the AP 102 may be a stationary non-mobile device. The STA 300 may be suitable for use as an STA 103 as depicted in FIG. 1, while the AP 350 may be suitable for use as an AP 102 as depicted in FIG. 1. In addition, the STA 300 may also be suitable for use as an HEW device 104 as shown in FIG. 1, such as an HEW station.

The STA 300 may include physical layer circuitry 302 and a transceiver 305, one or both of which may enable transmission and reception of signals to and from the AP 350, other APs, other STAs or other devices using one or more antennas 301. As an example, the physical layer circuitry 302 may perform various encoding and decoding functions that may include formation of baseband signals for transmission and decoding of received signals. As another example, the transceiver 305 may perform various transmission and reception functions such as conversion of signals between a baseband range and a Radio Frequency (RF) range. Accordingly, the physical layer circuitry 302 and the transceiver 305 may be separate components or may be part of a combined component. In addition, some of the described functionality related to transmission and reception of signals may be performed by a combination that may include one, any or all of the physical layer circuitry 302, the transceiver 305, and other components or layers.

The AP 350 may include physical layer circuitry 352 and a transceiver 355, one or both of which may enable transmission and reception for transmission and reception of signals to and from the STA 300, other APs, other STAs or other devices using one or more antennas 351. The physical layer circuitry 352 and the transceiver 355 may perform various functions similar to those described regarding the STA 300 previously. Accordingly, the physical layer circuitry 352 and the transceiver 355 may be separate components or may be part of a combined component. In addition, some of the described functionality related to transmission and reception of signals may be performed by a combination that may include one, any or all of the physical layer circuitry 352, the transceiver 355, and other components or layers.

The STA 300 may also include medium access control layer (MAC) circuitry 304 for controlling access to the wireless medium, while the AP 350 may also include medium access control layer (MAC) circuitry 354 for controlling access to the wireless medium. The STA 300 may also include processing circuitry 306 and memory 308 arranged to perform the operations described herein. The AP 350 may also include processing circuitry 356 and memory 358 arranged to perform the operations described herein. The AP 350 may also include one or more interfaces 260, which may enable communication with other components, including other APs 102 (FIG. 1). In addition, the interfaces 360 may enable communication with other components that may not be shown in FIG. 1, including components external to the network 100. The interfaces 360 may be wired or wireless or a combination thereof.

In some embodiments, the STA 300 may perform various operations as part of a low-power wake-up mode and may perform other operations as part of a normal mode. Those operations may include physical layer operations, MAC layer operations and/or other operations. The operations may be performed using components/memory shown in FIG. 3 for the STA 300, components/memory dedicated for the low-power wake-up mode or any combination of such components/memory. As an example, separate physical layer resources and/or MAC layer resources may be used for the low-power wake-up mode and normal mode, in some cases. As another example, components such as the physical layer circuitry 302, MAC layer circuitry 304, processing circuitry 306 and/or memory 308 may be used to perform operations for both modes.

The antennas 301, 351 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 301, 351 may be effectively separated to take advantage of spatial diversity and the different channel characteristics that may result.

In some embodiments, the STA 300 or the AP 350 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the STA 300 or AP 350 may be configured to operate in accordance with 802.11 standards, although the scope of the embodiments is not limited in this respect. Mobile devices or other devices in some embodiments may be configured to operate according to other protocols or standards, including other IEEE standards, Third Generation Partnership Project (3GPP) standards or other standards. In some embodiments, the STA 300, AP 350 or other device may include one or more of a keyboard, a display, a non-volatile memory port, multiple antennas, a graphics processor, an application processor, speakers, and other mobile device elements. The display may be an LCD screen including a touch screen.

Although the STA 300 and the AP 350 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the STA 300 and/or AP 350 may include various components of the STA 300 and/or AP 350 as shown in FIG. 3. Accordingly, techniques and operations described herein that refer to the STA 300 (or 103 or 104) may be applicable to an apparatus for an STA. In addition, techniques and operations described herein that refer to the AP 350 (or 102) may be applicable to an apparatus for an AP.

In some embodiments, the STA 300 may be configured as an HEW device 104 (FIG. 1), and may communicate using OFDM communication signals over a multicarrier communication channel. Accordingly, in some cases the STA 300 may be configured to receive signals in accordance with specific communication standards, such as the Institute of Electrical and Electronics Engineers (IEEE) standards including IEEE 802.11-2012, 802.11n-2009 and/or 802.11ac-2013 standards and/or proposed specifications for WLANs including proposed HEW standards, although the scope of the invention is not limited in this respect as they may also be suitable to transmit and/or receive communications in accordance with other techniques and standards. In some other embodiments, the STA 300 configured as an HEW device 104 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

Embodiments disclosed herein provide two preamble formats for High Efficiency (HE) Wireless LAN standards specification that is under development in the IEEE Task Group 11ax (TGax).

In accordance with embodiments, the STA 103 may transmit, to the AP 102, a wake-up configuration message that indicates a Resource Unit (RU) in which the STA 103 intends to monitor for wake-up messages from the AP 102 during a sleep period. The STA 103 may receive a wake-up message from the AP 102 during the sleep period. The wake-up message may be included in an orthogonal frequency division multiple-access (OFDMA) signal that may include other wake-up messages for other STAs 103. The wake-up message may be transmitted by the STA 103 in accordance with enhanced distributed channel access (EDCA) techniques in some cases. These embodiments will be described in more detail below. [0041.] In some embodiments, the channel resources may be used for downlink transmission by the AP 102 and for uplink transmissions by the STAs 103. That is, a time-division duplex (TDD) format may be used. In some cases, the channel resources may include multiple channels, such as the 20 MHz channels previously described. The channels may include multiple Resource Units (RUs) or may be divided into multiple RUs for the uplink transmissions to accommodate multiple access for multiple STAs 103. The downlink transmissions may or may not utilize the same format. It should be noted that reference herein to an “RU” is not limiting, as a “sub-channel” may be used in some embodiments.

In some embodiments, the downlink RUs may comprise a predetermined bandwidth. As a non-limiting example, the RUs may each span 2.03125 MHz, the channel may span 20 MHz, and the channel may include eight or nine RUs. Although reference may be made to an RU of 2.03125 MHz for illustrative purposes, embodiments are not limited to this example value, and any suitable frequency span for the RUs may be used. In some embodiments, the frequency span for the RU may be based on a value included in an 802.11 standard (such as 802.11ax), a 3GPP standard or other standard. As another non-limiting example, one or more of the RUs may span a bandwidth of 2.03125 MHz or larger. As another non-limiting example, an RU may include (or straddle) one or more direct current (DC) sub-carriers, in which case a real bandwidth of such an allocation may be larger than 2.03125 MHz. For instance, when 26 sub-carriers are included in the RU and no DC sub-carriers are included, the bandwidth may be (20 MHz/256)*26=2.03125 MHz. When 7 DC sub-carriers are included in an RU, the bandwidth may be (20 MHz/256)*(26+7)=2.578125 MHz. These examples are not limiting, as other RUs may include a different number of DC sub-carriers, in some cases.

In some embodiments, the RUs may comprise multiple sub-carriers. Although not limited as such, the sub-carriers may be used for transmission and/or reception of OFDM or OFDMA signals. As an example, each RU may include a group of contiguous sub-carriers spaced apart by a pre-determined sub-carrier spacing. As another example, each RU may include a group of non-contiguous sub-carriers. That is, the channel may be divided into a set of contiguous sub-carriers spaced apart by the pre-determined sub-carrier spacing, and each RU may include a distributed or interleaved subset of those sub-carriers. The sub-carrier spacing may take a value such as 78.125 kHz, 312.5 kHz or 15 kHz, although these example values are not limiting. Other suitable values that may or may not be part of an 802.11 or 3GPP standard or other standard may also be used in some cases. As an example, for a 78.125 kHz sub-carrier spacing, an RU may comprise 26 contiguous sub-carriers or a bandwidth of 2.0312.5 MHz. As another example, for a 78.125 kHz sub-carrier spacing, an RU that includes 26 non-contiguous sub-carriers and further includes (or straddles) 7 DC sub-carriers may span a bandwidth of 2.578125 MHz.

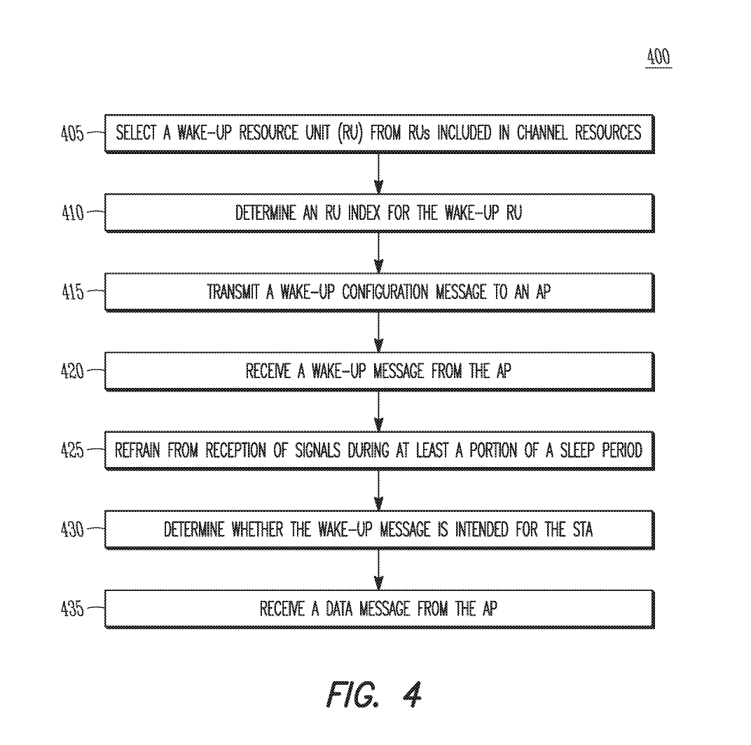

FIG. 4 illustrates the operation of a method of communication in accordance with some embodiments. It is important to note that embodiments of the method 400 may include additional or even fewer operations or processes in comparison to what is illustrated in FIG. 4. In addition, embodiments of the method 400 are not necessarily limited to the chronological order that is shown in FIG. 4. In describing the method 400, reference may be made to FIGS. 1-3 and 5-9, although it is understood that the method 400 may be practiced with any other suitable systems, interfaces and components.

In addition, while the method 400 and other methods described herein may refer to STAs 103 and APs 102 operating in accordance with 802.11 or other standards, embodiments of those methods are not limited to just those devices and may also be practiced on other mobile devices, such as an HEW STA, an HEW AP, an Evolved. Node-B (eNB) or User Equipment (UE). In some embodiments, the STA 103 described in the method 400 may be an HEW STA 103 while the AP 102 may be an HEW AP 102. The method 400 and other methods described herein may also be practiced by wireless devices configured to operate in other suitable types of wireless communication systems, including systems configured to operate according to various Third Generation Partnership Project (3GPP) Long Term Evolution (LTE) standards. The method 400 may also refer to an apparatus for an STA 103 and/or AP 102 or other device described above.

At operation 405 of the method 400, the STA 103 may select a wake-up Resource Unit (RU) in which the STA 103 intends to monitor for a wake-up message from the AP 102 during a sleep period of the STA 103. In some embodiments, the wake-up RU may be selected by the STA 103 to be used by the AP 102 for transmission of wake-up messages to the STA 103 during the sleep period of the STA 103. In some embodiments, the wake-up RU may be included in channel resources for which the STA 103 is configured to communicate with the AP 102. In some embodiments, the RUs may comprise a predetermined bandwidth and may further comprise multiple sub-carriers.

In some embodiments, during one or more sleep periods, the STA 103 may operate in a sleep mode which may include reduced operation in terms of reception of signals, transmission of signals and/or other operations. Accordingly, the STA 103 may operate in an active mode for reception and/or transmission of data signals, control signals and/or other signals. The wake-up message may serve as an indicator to the STA 103 to transition from the sleep mode to the active mode. Although embodiments are not limited as such, the active mode may be a normal mode of operation or a non-sleep mode of operation in some cases.

In some cases, the STA 103 may intend to monitor for wake-up messages during multiple sleep periods in the selected RU. The wake-up RU may be selected using any suitable technique, including but not limited to random selection. Embodiments are not limited to selection of the wake-up RU by the STA 103, as the wake-up RU may be determined in any suitable manner by the STA 103 and/or other component. For instance, the wake-up RU may be determined based on a predetermined assignment for the STA 103.

At operation 410, the STA 103 may determine an RU index for the wake-up RU. In some embodiments, the channel resources may include multiple RUs from which the wake-up RU may be selected. As a non-limiting example, the channel resources may include one or more channels, and one or more of the channels may include multiple RUs.

The RU index may be mapped to the RUs of the channel resources according to a mapping, which may be predetermined in some cases. In some embodiments, the RU index may be one of a group of RU indexes that are mapped to the RUs included in the channel resources. As an example, the mapping may be based on or may be a function of a channel bandwidth of the channel resources. For instance, a first mapping may be used for a first channel bandwidth of the channel resources and a second mapping may be used for a second channel bandwidth of the channel resources. Example mappings between RUs and RU indexes are described herein. In some embodiments, the RU indexes in the group may be mapped to carrier frequencies and/or center frequencies of corresponding RUs.

At operation 415, the STA 103 may transmit a wake-up configuration message to the AP 102. In some embodiments, the wake-up message may be transmitted using enhanced distributed channel access (EDCA) techniques, although embodiments are not limited as such. The wake-up configuration message may include any number of parameters or information that may indicate the wake-up RU or other related information. Non-limiting examples of such parameters may include an indicator of a channel bandwidth of the channel resources, a channel index that indicates a channel in which the wake-up RU is included, an RU index for the wake-up RU, a bandwidth for the wake-up message to be used by the AP 102 and/or other parameters.

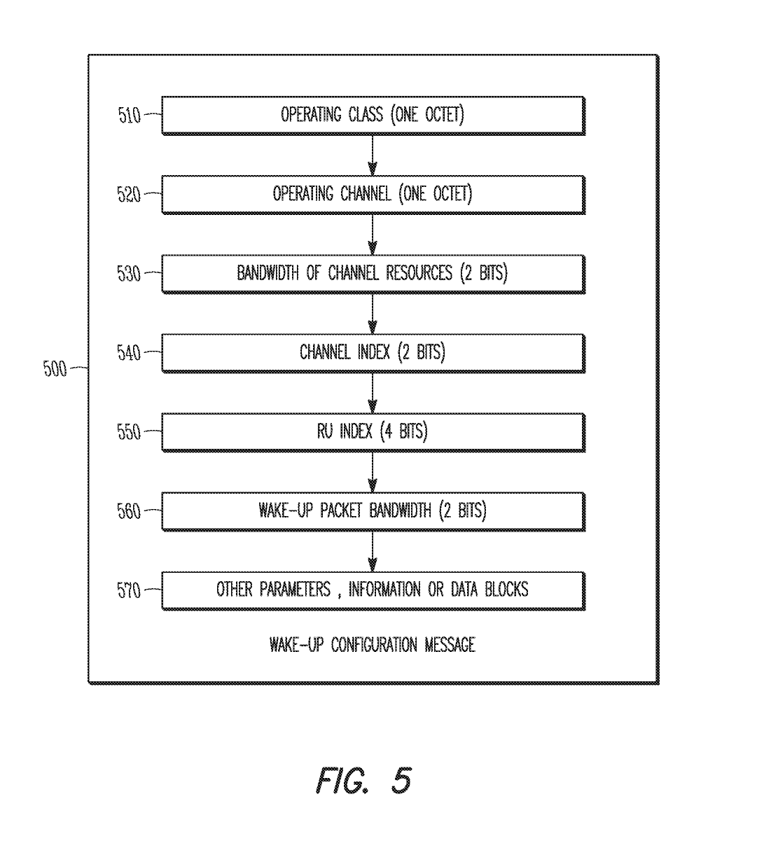

FIG. 5 illustrates an example of a wake-up configuration message in accordance with some embodiments. The example wake-up configuration message 500 shown in FIG. 5 may be used to illustrate concepts associated with the method 400 and/or other methods, but the scope of the embodiments is not limited by this example. In addition, formats and arrangements of the wake-up configuration message 500 and parameters as shown in FIG. 5 are also not limiting. Some embodiments may not necessarily include all parameters shown in FIG. 5, and some embodiments may include additional parameters not shown in FIG. 5. Embodiments are also not limited to the example lengths of the parameters shown in FIG. 5.

Referring to FIG. 5, the wake-up configuration message 500 may include an operating class 510 of the STA 103 and/or an operating channel 520 of the STA 103. The wake-up configuration message 500 may also include a bandwidth of the channel resources 530. As an example, a bandwidth of 20, 40 or 80 MHz may be indicated. The wake-up configuration message 500 may include a channel index 540, which may indicate which channel of the channel resources includes the wake-up RU. As an example, the channel resources may include one or more channels of 20 MHz bandwidth, and the channel index may indicate which 20 MHz channel includes the wake-up RU. The wake-up configuration message 500 may include an RU index 550. As an example, the channel (of 20 MHz or other bandwidth) may include multiple RUs which may be mapped to a group of RU indexes. The wake-up configuration message 500 may include a wake-up packet bandwidth 560, which may indicate a bandwidth to be used for a wake-up packet transmitted as part of the wake-up message. As an example, at least a portion of the wake-up RU (or the sub-carriers included in the wake-up RU) may be used for the wake-up packet. The wake-up packet bandwidth 560 may indicate a size of the portion and/or whether all the sub-carriers in the wake-up RU are used.

It should also be noted that the wake-up configuration message 500 may also include any number (including zero) of other parameters, information or data blocks 570, such as other parameters for the wake-up RU, control information for the wake-up configuration message 500 and/or other.

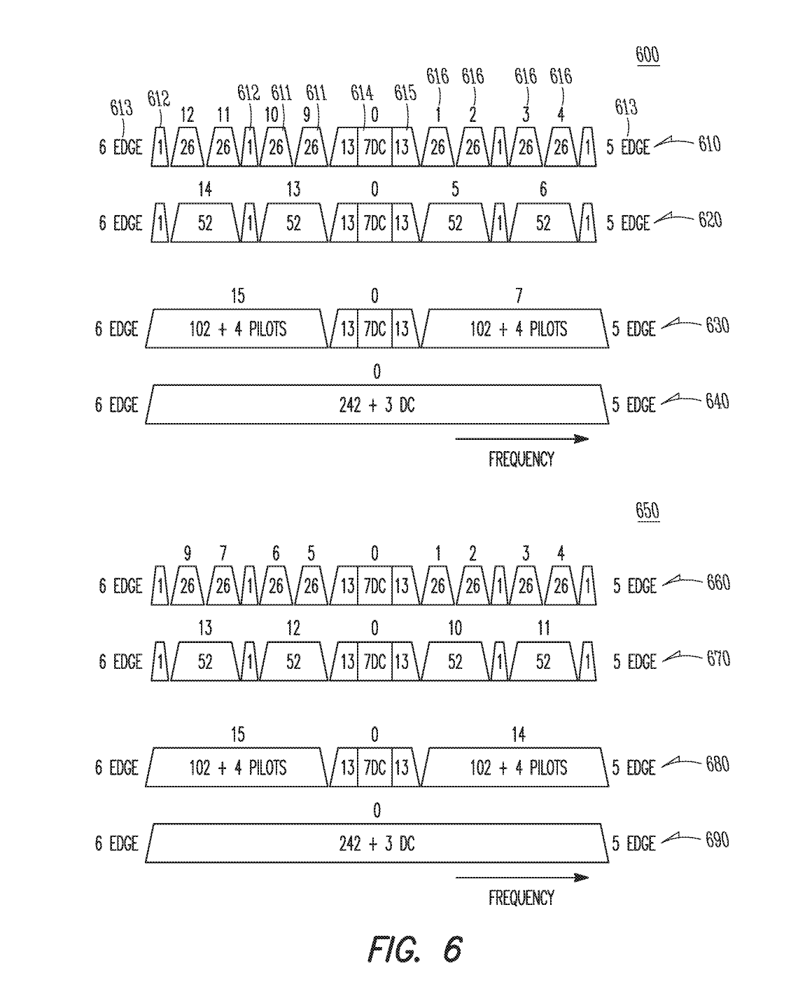

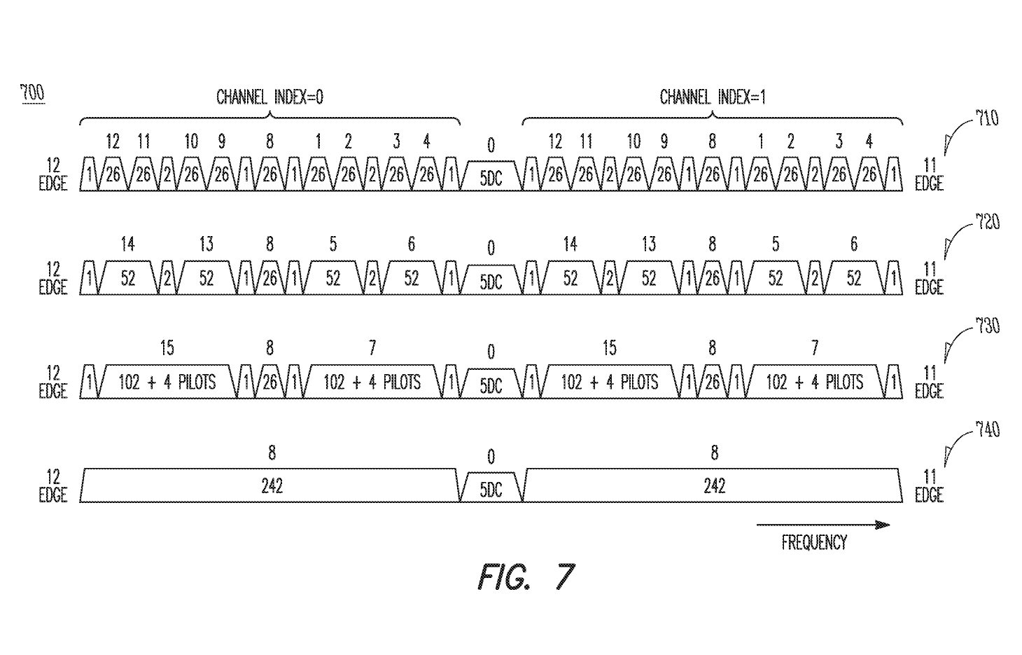

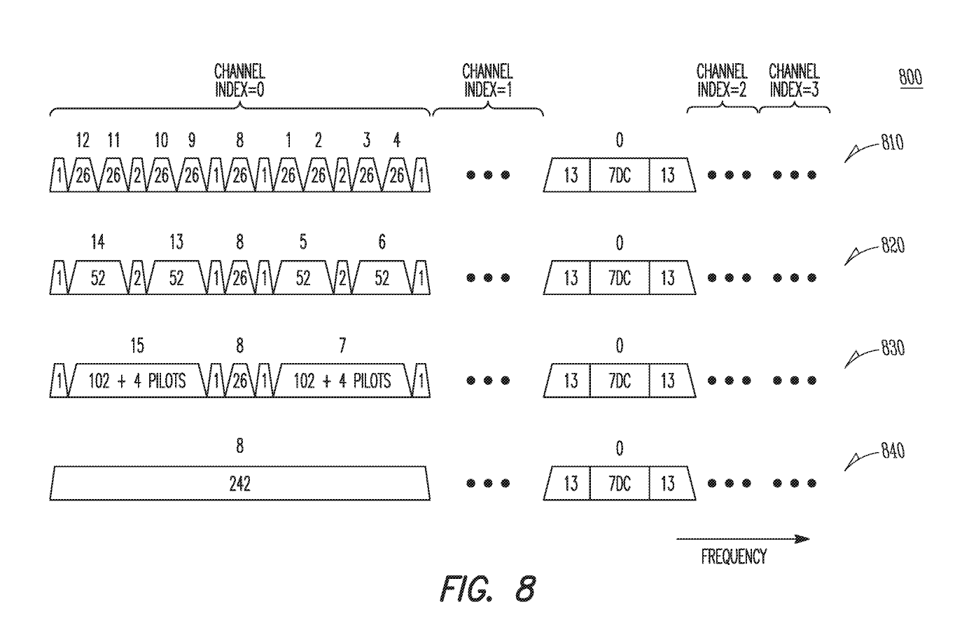

FIG. 6 illustrates example mappings between Resource Unit (RU) indexes and RU frequencies in accordance with some embodiments. FIG. 7 illustrates example mappings between RU indexes and RU frequencies in accordance with some embodiments. FIG. 8 illustrates example mappings between RU indexes and RU frequencies in accordance with some embodiments. It should be noted that the example mappings in FIGS. 6-8 may illustrate some or all concepts and/or techniques described herein. However, embodiments are not limited by the example mappings shown in FIGS. 6-8 in terms of arrangement, mapping, indexing or labeling. In addition, embodiments are not limited by the number, arrangement, distribution or type of sub-carriers shown. Embodiments are also not limited to the channel bandwidths shown, and may be modified to accommodate other channel bandwidths in some cases.

The example mapping 600 illustrates an assignment of RU indexes to RUs for four different scenarios in which a single channel is allocated. As a non-limiting example, a channel bandwidth of 20 MHz may be used. In the first scenario 610, the channel resources include multiple RUs generally comprising 26 sub-carriers as shown by the label “26” in boxes such as 611. The channel resources further comprise multiple groups of pilot sub-carriers with a single pilot sub-carrier in each group in this case, as shown by the label “1” in boxes such as 612. The channel resources further comprise a group of direct current (DC) sub-carriers with 7 such DC sub-carriers in this case, as shown by the label “7” in box 614. The channel resources further comprise multiple groups of 13 data sub-carriers, as shown by the label “13” in boxes such as 615. In addition, a number of edge sub-carriers 613 are shown, with 6 edge sub-carriers on the lower end of the frequency range and 5 edge sub-carriers on the upper end of the frequency range.

In the example mapping 600, an RU index 616 is shown above the RUs. For instance, in the first scenario 610, the RUs from in increasing frequency order are assigned the RU index 616 of 12, 11, 19, 9, 1, 2, 3 and 4. The combination of the 7 DC sub-carriers 614 and the two blocks of 13 sub-carriers 615 may be an RU that is assigned the RU index of 0.

In the second scenario 620, the RUs comprise 52 sub-carriers as shown, which are labeled as 14, 13, 5, and 6 in increasing order of frequency. In the third scenario 630, the RUs comprise 102 sub-carriers as shown, which are labeled as 15 and 7 in increasing order of frequency. It should be noted that the RU may be included in a block of sub-carriers that also includes 4 pilots distributed or allocated in any suitable manner. In the fourth scenario 640, a single RU comprises 242 sub-carriers as shown, which is assigned an RU index of 0. It should be noted that the configuration of data, pilot, DC and edge sub-carriers may be predetermined and/or preconfigured, such as through control messages and/or setup messages.

In the example mapping 650, scenarios 660-690 illustrate a different mapping of RU indexes to the same sub-carrier configurations shown in scenarios 610-640.

The example mapping 700 illustrates an assignment of RU indexes to RUs for four different scenarios in which two channels are allocated. As a non-limiting example, a channel bandwidth of 20 MHz may be used for each channel or 40 MHz for the channel resources. In the scenarios 710-740, RUs, pilot sub-carriers, DC sub-carriers, and edge sub-carriers are allocated in a similar manner as in the scenarios 610-640 in FIG. 6. The lower channel is mapped to a channel index of “0” while the upper channel is mapped to a channel index of “1.” Accordingly, the channel (of the lower or upper) that includes the wake-up RU may be indicated in the wake-up configuration message. As in the scenarios 610-640, RU indexes for the RUs are indicated above the RUs for the example mapping.

It should be noted that the RU at the center of the channels are assigned an RU index of 8 while the DC sub-carriers in between the channels are assigned an RU index of 0. It should be noted that in such a case, the center of the wake-up packet transmission may be the center of the DC sub-carriers and some of the data sub-carriers surrounding the DC sub-carriers may be used for the wake-up packet. Accordingly, the RU index may indicate a center frequency in which the AP 102 is to transmit the wake-up packet.

The example mapping 800 illustrates an assignment of RU indexes to RUs for four different scenarios in which four channels are allocated. As a non-limiting example, a channel bandwidth of 20 MHz may be used for each channel or 80 MHz for the channel resources. In the scenarios 810-840, RUs, pilot sub-carriers, DC sub-carriers, and edge sub-carriers are allocated in a similar manner as in the scenarios 810-840 in FIG. 8. The four channels (from lowest to highest in frequency, are mapped to channel indexes of 0, 1, 2, and 3. Accordingly, the channel of the four that includes the wake-up RU may be indicated in the wake-up configuration message. As in the scenarios 610-640, RU indexes for the RUs are indicated above the RUs for the example mapping.

Returning to the method 400, at operation 420, the STA 103 may receive a wake-up message from the AP 102. As a non-limiting example, the wake-up message may serve as an indicator to the STA 103 to transition from the sleep mode into an active mode for reception of data messages and/or other messages.

In some embodiments, the wake-up message may be received from the AP 102 during a TXOP obtained by the AP. Although embodiments are not limited as such, the wake-up message may be included as part of an OFDMA signal. In some cases, the OFDMA signal may include multiple wake-up messages (and/or other messages) intended for multiple STAs 103. For instance, the OFDMA signal that includes the wake-up message for the STA 103 may also include a data packet and/or message that may be intended for another STA 103. As a non-limiting example, the wake-up configuration message may be transmitted by the STA 103 at operation 415 using EDCA techniques while OFDMA techniques may be used for the transmission of the wake-up message by the AP 102.

In some embodiments, the wake-up message may be received during a sleep period of the STA 103. At operation 425, the STA 103 may refrain from reception of signals during at least a portion of the sleep period. In some embodiments, the STA 103 may refrain from reception and/or transmission of signals during at least a portion of the sleep period. In some cases, the STA 103 may operate in a low power mode during the sleep period.

At operation 430, the STA 103 may determine whether the wake-up message is intended for the STA 103. In some embodiments, the determination may be based on a decoded identifier of the STA 103 included in the received wake-up message. In some cases, the STA 103 and one or more other STAs 103 may indicate the same wake-up RU to the AP 102, in which case the AP 102 may transmit a wake-up message on the wake-up RU that may be intended for one of the other STAs 103. In such a case, the STA 103 may receive the wake-up message and determine that it is not intended for the STA 103.

At operation 435, the STA 103 may receive a data message from the AP 102. In some embodiments, the data message may be received after the STA 103 has transitioned from the sleep mode into the active mode. As a non-limiting example, the wake-up message may be transmitted by the AP 102 to notify the STA 103 that it is to transition from the sleep mode to the active mode for reception of the data message. Accordingly, the STA 103 may transition from the sleep mode to the active mode in response to the reception of the wake-up message and/or the determination that the wake-up message is intended for the STA 103.

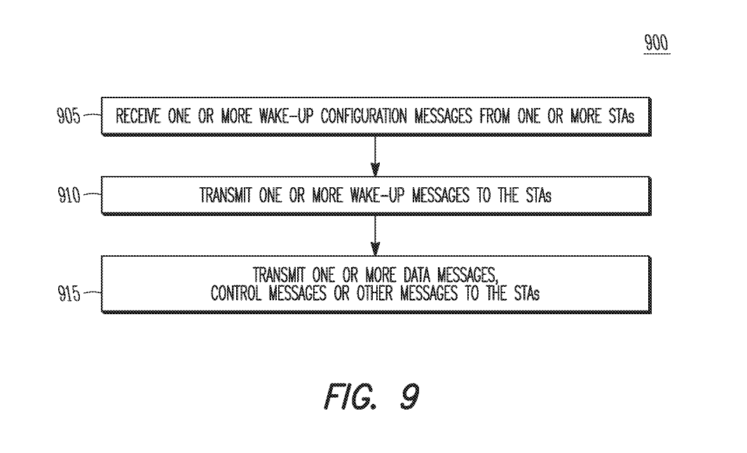

FIG. 9 illustrates the operation of another method of communication in accordance with some embodiments. As mentioned previously regarding the method 400, embodiments of the method 900 may include additional or even fewer operations or processes in comparison to what is illustrated in FIG. 9 and embodiments of the method 900 are not necessarily limited to the chronological order that is shown in FIG. 9. In describing the method 900, reference may be made to FIGS. 1-8, although it is understood that the method 900 may be practiced with any other suitable systems, interfaces and components. In addition, embodiments of the method 900 may refer to APs, STAs, eNBs 104, UEs 102, HEW APs, HEW STAs or other wireless or mobile devices. The method 900 may also refer to an apparatus for an STA 103 and/or AP 102 or other device described above.

It should be noted that the method 900 may be practiced at an AP 102, and may include exchanging of signals or messages with an STA 103. Similarly, the method 400 may be practiced at the STA 103, and may include exchanging of signals or messages with the AP 102. In some cases, operations and techniques described as part of the method 400 may be relevant to the method 900. In addition, embodiments may include operations performed at the AP 102 that are reciprocal or similar to other operations described herein performed at the STA 103. For instance, an operation of the method 900 may include reception of a message by the AP 102 while an operation of the method 400 may include transmission of the same message or similar message by the STA 103.

In addition, previous discussion of various techniques and concepts may be applicable to the method 900 in some cases, including the wake-up configuration message, wake-up message, sleep mode, active mode, sleep periods, and others. Other concepts previously described, such as the channel resources, channels, RUs, sub-channels, and sub-carriers may also be applicable to the method 900 in some cases. In addition, the example mappings of RU indexes shown in FIGS. 6-8 may also be applicable to the method 900 in some cases.

At operation 905, the AP 102 may receive one or more wake-up configuration messages from one or more STAs 103. Although not limited as such, previously described concepts regarding the wake-up configuration messages may be applicable in some cases. For instance, a wake-up configuration message may indicate a wake-up RU by a wake-up RU index determined by a mapping between RU indexes and RUs included in the channel resources. The wake-up RU may be included in channel resources used for communication between the AP 102 and the STA 103. In some cases, the mapping between RU indexes and RUs may be based on a channel bandwidth of the channel resources.

As an example, a first wake-up configuration message may be received from a first STA 103 to indicate an intention of the first STA 103 to operate in a sleep mode. The message may include and/or indicate an RU in which the first STA 103 intends to receive wake-up messages from the AP 102 during one or more sleep periods of the first STA 103.

As another example, wake-up configuration messages received from multiple STAs 103 may indicate the same wake-up RU. In such cases, the AP 102 may include an STA identifier in a transmitted wake-up message to enable the STAs 103 to determine the intended recipient of the wake-up message.

As another example, a first STA 103 may be configured to communicate with the AP 102 in first channel resources of a first bandwidth and a second STA 103 may be configured to communicate with the AP 102 in second channel resources of a second bandwidth. If the first and second bandwidths are different, it may be possible that mappings between RUs and RU indexes for the first and second STAs 103 are different. Accordingly, wake-up configuration messages transmitted by the first and second STAs 103 may include wake-up RU indexes based on different mappings.

At operation 910, the AP 102 may transmit one or more wake-up messages to the STAs to indicate that the STAs are to transition from the sleep mode to an active mode. The wake-up messages may be transmitted in wake-up RUs indicated in the wake-up configuration messages. Although not limited as such, previously described concepts regarding the wake-up message may be applicable in some cases. As an example, the AP 102 may transmit a first wake-up message to a first STA 103 in a first wake-up RU to indicate that the first STA is to transition from the sleep mode to the active mode. As another example, the AP 102 may also transmit a second wake-up message to a second STA 103 in a second wake-up RU to indicate that the second. STA is to transition from the sleep mode to the active mode. The first and second wake-up messages may be included as part of a same OFDMA signal in some cases.

At operation 915, the AP 102 may transmit one or more data messages, control messages or other messages to one or more of the STAs 103. Although not limited as such, the AP 102 may transmit a wake-up message to a particular STA 103 when the AP 102 intends to transmit a data message, control message or other message to the STA 103.

In some embodiments, EDCA techniques may be used for uplink messages (such as the wake-up configuration messages) while OFDMA techniques may be used for downlink messages (such as the wake-up messages). In some embodiments, the messages transmitted by the AP 102 in operation 910 and/or operation 915 may be transmitted during a TXOP obtained by the AP 102. In some embodiments, multi-user multiple-input multiple-output (MU-MEMO) techniques may be used for the transmissions performed by the AP 102 in operation 910 and/or operation 915.

In Example 1, an apparatus for a station (STA) may comprise transceiver circuitry and hardware processing circuitry. The hardware processing circuitry may configure the transceiver circuitry to transmit, to an access point (AP), a wake-up configuration message that indicates a wake-up resource unit (RU) in which the STA intends to monitor for a wake-up message from the AP during a sleep period of the STA. The wake-up RU may be included in channel resources for which the STA is configured to communicate with the AP. The wake-up configuration message may include an indicator of a channel bandwidth of the channel resources and further includes an RU index for the wake-up RU.

In Example 2, the subject matter of Example 1, wherein the hardware processing circuitry may further configure the transceiver circuitry to receive, from the AP during a transmission opportunity (TXOP) obtained by the AP, the wake-up message in the wake-up RU during the sleep period. The wake-up message may be included as part of an orthogonal frequency division multiple access (OFDMA) signal. The wake-up configuration message may be transmitted by the STA to the AP in accordance with an enhanced distributed channel access (ECDA).

In Example 3, the subject matter of one or any combination of Examples 1-2, wherein the RU index may be one of a group of RU indexes that are mapped, according to a mapping based on the channel bandwidth of the channel resources, to RUs included in the channel resources.

In Example 4, the subject matter of one or any combination of Examples 1-3, wherein the group of RU indexes may be mapped to carrier frequencies of the RUs included in the channel resources.

In Example 5, the subject matter of one or any combination of Examples 1-4, wherein the RUs may comprise a predetermined bandwidth and further comprise multiple sub-carriers.

In Example 6, the subject matter of one or any combination of Examples 1-5, wherein the channel resources may include one or more channels that include multiple RUs. The wake-up configuration message may further include a channel index that indicates a channel in which the wake-up RU is included.

In Example 7, the subject matter of one or any combination of Examples 1-6, wherein the channels may comprise a 20 MHz bandwidth and the channel bandwidth of the channel resources may be included in a group that includes 20 MHz, 40 MHz, 80 MHz, and 160 MHz.

In Example 8, the subject matter of one or any combination of Examples 1-7, wherein the wake-up configuration message may further indicate a bandwidth for the wake-up message to be used by the AP.

In Example 9, the subject matter of one or any combination of Examples 1-8, wherein the hardware processing circuitry may be configured to select the wake-up RU from the RUs included in the channel resources. The hardware processing circuitry may be further configured to determine the RU index for the wake-up RU.

In Example 10, the subject matter of one or any combination of Examples 1-9, wherein the hardware processing circuitry may be configured to determine, based on an STA identifier included in the wake-up message, whether the wake-up message is intended for the STA.

In Example 11, the subject matter of one or any combination of Examples 1-10, wherein the hardware processing circuitry may further configure the transceiver circuitry to refrain from reception of signals during at least a portion of the sleep period.

In Example 12, the subject matter of one or any combination of Examples 1-11, wherein the STA may be configured to operate according to a wireless local area network (WLAN) protocol.

In Example 13, the subject matter of one or any combination of Examples 1-12, wherein the apparatus may further comprise one or more antennas coupled to the transceiver circuitry for the transmission of the wake-up configuration message and for the reception of the wake-up message.

In Example 14, a non-transitory computer-readable storage medium may store instructions for execution by one or more processors to perform operations for communication by a station (STA). The operations may configure the one or more processors to select a wake-up resource unit (RU) to be used by an access point (AP) for transmission of wake-up messages to the STA during a sleep period of the STA. The wake-up RU may be included in channel resources for which the STA is configured to communicate with the AP. The operations may further configure the one or more processors to configure the STA to transmit, to the AP, a wake-up configuration message that indicates an RU index for the wake-up RU and further indicates a channel bandwidth of the channel resources. The operations may configure the one or more processors to configure the STA to receive a wake-up message from the AP in the wake-up RU during the sleep period. The channel resources may include multiple RUs that are mapped to RU indexes according to a predetermined mapping that depends on the channel bandwidth of the channel resources.

In Example 15, the subject matter of Example 14, wherein the RUs may comprise a predetermined bandwidth and further comprise multiple sub-carriers. The wake-up message may include an orthogonal frequency division multiple access (OFDMA) signal.

In Example 16, the subject matter of one or any combination of Examples 14-15, wherein the channel resources may include one or more channels that include multiple RUs. The wake-up configuration message may further include a channel index that indicates a channel in which the wake-up RU is included. The wake-up configuration message may further indicate a bandwidth for the wake-up message to be used by the AP.

In Example 17, the subject matter of one or any combination of Examples 14-16, wherein the channel bandwidth of the channel resources may be included in a group that includes 20 MHz, 40 MHz, 80 MHz, and 160 MHz. The channel resources may include one or more 20 MHz channels. The STA may be configured to operate according to a wireless local area network (WLAN) protocol.

In Example 18, the subject matter of one or any combination of Examples 14-17, wherein the wake-up message may be received during a transmission opportunity (TROP) obtained by the AP. The wake-up message may be included as part of an orthogonal frequency division multiple access (OFDMA) signal. The wake-up configuration message may be transmitted by the STA to the AP in accordance with an enhanced distributed channel access (ECDA).

In Example 19, a method of communication performed at a station (STA) may comprise transmitting, to an access point (AP), a wake-up configuration message that indicates a wake-up resource unit (RU) in which the STA intends to monitor for a wake-up message from the AP during a sleep period of the STA. The wake-up RU may be included in channel resources for which the STA is configured to communicate with the AP. The wake-up configuration message may include an indicator of a channel bandwidth of the channel resources and further includes an RU index for the wake-up RU. The RU index may be selected from a group of candidate RU indexes that are mapped, according to a mapping based on the channel bandwidth of the channel resources, to RUs included in the channel resources.

In Example 20, the subject matter of Example 19, wherein the method may further comprise receiving, from the AP, the wake-up message in the wake-up RU during the sleep period. The method may further comprise refraining from reception of signals during at least a portion of the sleep period.

In Example 21, an apparatus for an access point (AP) may comprise transceiver circuitry and hardware processing circuitry. The hardware processing circuitry may configure the transceiver circuitry to receive, from a station (STA), a wake-up configuration message that indicates an intention of the STA to operate in a sleep mode. The hardware processing circuitry may further configure the transceiver circuitry to transmit a wake-up message to the STA to indicate that the STA is to transition from the sleep mode to an active mode. The wake-up message may be transmitted in a wake-up RU indicated in the wake-up configuration message. The wake-up RU may be included in channel resources used for communication between the AP and the STA. The wake-up RU may be indicated in the wake-up configuration message by a wake-up RU index that is determined by a mapping between RU indexes and RUs included in the channel resources. The mapping may be based on a channel bandwidth of the channel resources.

In Example 22, the subject matter of Example 21, wherein the wake-up message may be transmitted during a transmission opportunity (TXOP) obtained by the AP. The wake-up message may be included as part of an orthogonal frequency division multiple access (OFDMA) signal that includes another wake-up message intended for another STA. The wake-up configuration message may be received from the STA in accordance with an enhanced distributed channel access (ECDA).

In Example 23, the subject matter of one or any combination of Examples 21-22, wherein the wake-up message may be transmitted in accordance with a multi-user multiple-input multiple-output (MU-MIMO) transmission.

In Example 24, the subject matter of one or any combination of Examples 21-23, wherein the wake-up configuration message may further indicate the channel bandwidth of the channel resources.

In Example 25, the subject matter of one or any combination of Examples 21-24, wherein the channel resources may include one or more channels that include multiple RUs. The wake-up configuration message may further include a channel index that indicates a channel in which the wake-up RU is included. The wake-up configuration message may further indicate a bandwidth for the wake-up message to be used by the AP.

In Example 26, the subject matter of one or any combination of Examples 21-25, wherein the channels may comprise a 20 MHz bandwidth and the channel bandwidth of the channel resources may be included in a group that includes 20 MHz, 40 MHz, 80 MHz, and 160 MHz.

In Example 27, the subject matter of one or any combination of Examples 21-26, wherein the STA may be a first STA, the wake-up configuration message may be a first wake-up configuration message, the wake-up RU may be a first wake-up RU, the mapping may be a first mapping, and the channel bandwidth may be a first channel bandwidth. The hardware processing circuitry may further configure the transceiver circuitry to receive a second wake-up configuration message from a second STA that includes a second wake-up RU index to indicate a second wake-up RU for the second STA. The second wake-up RU index may be determined by a second, different mapping based on a second channel bandwidth.

In Example 28, the subject matter of one or any combination of Examples 21-27, wherein the AP may be configured to operate according to a wireless local area network (WEAN) protocol.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a station (STA), the apparatus comprising transceiver circuitry and hardware processing circuitry, the hardware processing circuitry to configure the transceiver circuitry to:
transmit, to an access point (AP), a wake-up configuration message that indicates a wake-up resource unit (RU) in which the STA intends to monitor for a wake-up message from the AP during a sleep period of the STA,
wherein the wake-up RU is included in channel resources for which the STA is configured to communicate with the AP,
wherein the wake-up configuration message includes an indicator of a channel bandwidth of the channel resources and further includes an RU index for the wake-up RU.

2. The apparatus according to claim 1, the hardware processing circuitry to further configure the transceiver circuitry to:
receive, from the AP during a transmission opportunity (TROP) obtained by the AP, the wake-up message in the wake-up RU during the sleep period,
wherein the wake-up message is included as part of an orthogonal frequency division multiple access (OFDMA) signal, and
wherein the wake-up configuration message is transmitted by the STA to the AP in accordance with an enhanced distributed channel access (ECDA).

3. The apparatus according to claim 2, wherein the RU index is one of a group of RU indexes that are mapped, according to a mapping based on the channel bandwidth of the channel resources, to RUs included in the channel resources.

4. The apparatus according to claim 3, wherein the group of RU indexes are mapped to carrier frequencies of the RUs included in the channel resources.

5. The apparatus according to claim 2, wherein the RUs comprise a predetermined bandwidth and further comprise multiple sub-carriers.

6. The apparatus according to claim 2, wherein:
the channel resources include one or more channels that include multiple RUs, and
the wake-up configuration message further includes a channel index that indicates a channel in which the wake-up RU is included.

7. The apparatus according to claim 6, wherein the channels comprise a 20 MHz bandwidth and the channel bandwidth of the channel resources is included in a group that includes 20 MHz, 40 MHz, 80 MHz, and 160 MHz.

8. The apparatus according to claim 6, wherein the wake-up configuration message further indicates a bandwidth for the wake-up message to be used by the AP.

9. The apparatus according to claim 2, the hardware processing circuitry configured to:
select the wake-up RU from the RUs included in the channel resources; and
determine the RU index for the wake-up RU.

10. The apparatus according to claim 2, the hardware processing circuitry configured to determine, based on an STA identifier included in the wake-up message, whether the wake-up message is intended for the STA.

11. The apparatus according to claim 2, the hardware processing circuitry to further configure the transceiver circuitry to refrain from reception of signals during at least a portion of the sleep period.

12. The apparatus according to claim 1, wherein the STA is configured to operate according to a wireless local area network (WLAN) protocol.

13. The apparatus according to claim 1, the apparatus further comprising one or more antennas coupled to the transceiver circuitry for the transmission of the wake-up configuration message and for the reception of the wake-up message.

14. A non-transitory computer-readable storage medium that stores instructions for execution by one or more processors to perform operations for communication by a station (STA), the operations to configure the one or more processors to:
select a wake-up resource unit (RU) to be used by an access point (AP) for transmission of wake-up messages to the STA during a sleep period of the STA, the wake-up RU included in channel resources for which the STA is configured to communicate with the AP;
configure the STA to transmit, to the AP, a wake-up configuration message that indicates an RU index for the wake-up RU and further indicates a channel bandwidth of the channel resources; and
configure the STA to receive a wake-up message from the AP in the wake-up RU during the sleep period,
wherein the channel resources include multiple RUs that are mapped to RU indexes according to a predetermined mapping that depends on the channel bandwidth of the channel resources.

15. The non-transitory computer-readable storage medium according to claim 14, wherein:
the RUs comprise a predetermined bandwidth and further comprise multiple sub-carriers, and
the wake-up message includes an orthogonal frequency division multiple access (OFDMA) signal.

16. The non-transitory computer-readable storage medium according to claim 14, wherein:
the channel resources include one or more channels that include multiple RUs,
the wake-up configuration message further includes a channel index that indicates a channel in which the wake-up RU is included, and
the wake-up configuration message further indicates a bandwidth for the wake-up message to be used by the AP.

17. The non-transitory computer-readable storage medium according to claim 14, wherein:
the channel bandwidth of the channel resources is included in a group that includes 20 MHz, 40 MHz, 80 MHz, and 160 MHz,
the channel resources include one or more 20 MHz channels, and
the STA is configured to operate according to a wireless local area network (WLAN) protocol.

18. The non-transitory computer-readable storage medium according to claim 14, wherein:
the wake-up message is received during a transmission opportunity (TROP) obtained by the AP,
the wake-up message is included as part of an orthogonal frequency division multiple access (OFDMA) signal, and
the wake-up configuration message is transmitted by the STA to the AP in accordance with an enhanced distributed channel access (ECDA).

19. A method of communication performed at a station (STA), the method comprising:
transmitting, to an access point (AP), a wake-up configuration message that indicates a wake-up resource unit (RU) in which the STA intends to monitor for a wake-up message from the AP during a sleep period of the STA,
wherein the wake-up RU is included in channel resources for which the STA is configured to communicate with the AP,
wherein the wake-up configuration message includes an indicator of a channel bandwidth of the channel resources and further includes an RU index for the wake-up RU, and
wherein the RU index is selected from a group of candidate RU indexes that are mapped, according to a mapping based on the channel bandwidth of the channel resources, to RUs included in the channel resources.

20. The method according to claim 19, the method further comprising:
receiving, from the AP, the wake-up message in the wake-up RU during the sleep period; and
refraining from reception of signals during at least a portion of the sleep period.

21. An apparatus for an access point (AP), the apparatus comprising transceiver circuitry and hardware processing circuitry, the hardware processing circuitry to configure the transceiver circuitry to:
receive, from a station (STA), a wake-up configuration message that indicates an intention of the STA to operate in a sleep mode; and
transmit a wake-up message to the STA to indicate that the STA is to transition from the sleep mode to an active mode, the wake-up message transmitted in a wake-up RU indicated in the wake-up configuration message,
wherein the wake-up RU is included in channel resources used for communication between the AP and the STA, and
wherein the wake-up RU is indicated in the wake-up configuration message by a wake-up RU index that is determined by a mapping between RU indexes and RUs included in the channel resources, the mapping based on a channel bandwidth of the channel resources.

22. The apparatus according to claim 21, wherein:
the wake-up message is transmitted during a transmission opportunity (TXOP) obtained by the AP,
the wake-up message is included as part of an orthogonal frequency division multiple access (OFDMA) signal that includes another wake-up message intended for another STA, and
the wake-up configuration message is received from the STA in accordance with an enhanced distributed channel access (ECDA).

23. The apparatus according to claim 22, wherein the wake-up message is transmitted in accordance with a multi-user multiple-input multiple-output (MU-MIMO) transmission.

24. The apparatus according to claim 21, wherein the wake-up configuration message further indicates the channel bandwidth of the channel resources.

25. The apparatus according to claim 24, wherein:
the channel resources include one or more channels that include multiple RUs,
the wake-up configuration message further includes a channel index that indicates a channel in which the wake-up RU is included, and
the wake-up configuration message further indicates a bandwidth for the wake-up message to be used by the AP.

26. The apparatus according to claim 25, wherein the channels comprise a 20 MHz bandwidth and the channel bandwidth of the channel resources is included in a group that includes 20 MHz, 40 MHz, 80 MHz, and 160 MHz.

27. The apparatus according to claim 21, wherein:
the STA is a first STA, the wake-up configuration message is a first wake-up configuration message, the wake-up RU is a first wake-up RU, the mapping is a first mapping, and the channel bandwidth is a first channel bandwidth,
the hardware processing circuitry is to further configure the transceiver circuitry to receive a second wake-up configuration message from a second STA that includes a second wake-up RU index to indicate a second wake-up RU for the second STA, and
the second wake-up RU index is determined by a second, different mapping based on a second channel bandwidth.

28. The apparatus according to claim 21, wherein the AP is configured to operate according to a wireless local area network (WLAN) protocol.
